(19) United States
(12) Patent Application Publication
(10) Pub. No.: US 2024/0255039 A1
(43) Pub. Date: Aug. 1, 2024

(54) SPRING APPLIED HYDRAULIC RELEASE CALIPER BRAKE AND METHODS OF ADJUSTMENT

(71) Applicant: Ausco Products, Inc., Benton Harbor, MI (US)

(72) Inventors: Peter Pozivilko, St. Joseph, MI (US); LynRoy Palmer-Coleman, St. Joseph, MI (US); Christopher L. Granacki, New Carlisle, IN (US)

(21) Appl. No.: 18/233,030

(22) Filed: Aug. 11, 2023

Related U.S. Application Data
(60) Provisional application No. 63/441,552, filed on Jan. 27, 2023.

(51) Int. Cl. F16D 65/46; B60T 13/22; F16D 65/18

(52) U.S. Cl. CPC F16D 65/46; B60T 13/22; F16D 65/18; B60T 1/065; F16D 2065/383; F16D 2121/06; F16D 2127/04

(57) ABSTRACT

A spring applied hydraulic release caliper brake includes a housing carrying springs acting on a piston in a default position. The housing further carries an adjuster, with an outer portion of the adjuster being in direct contact with an outermost spring of the springs. A released position of the brake includes the piston being in contact with the adjuster. The adjuster is adapted to rotate a predetermined amount to thereby cause the adjuster to act on the springs. This removes an amount of clearance between the piston and a stator, such that the removal of the amount of clearance becomes a new default position for the spring applied hydraulic release caliper brake.

### CROSS REFERENCE TO RELATED APPLICATIONS

This application claims the benefit of U.S. Provisional Application No. 63/441,552, filed Jan. 27, 2023, which is incorporated herein by reference.

### TECHNICAL FIELD

One or more embodiments of this invention relate to a spring applied hydraulic release caliper brake. One or more embodiments of this invention relate to a method of adjusting a spring applied hydraulic release caliper brake.

### BACKGROUND

A certain conventional brake includes a Belleville spring pack in position between a piston and an end cap. The end cap is rigidly bolted to the body of the brake, so the end cap position is fixed. A screw is threaded into the piston and is locked in axial position relative to the piston by a locknut. Thus, the screw and the locknut move axially with the piston. The spring pack urges the piston toward a stator backing plate, and the screw moves with the piston to thereby push on a pin, which pin is slidably mounted inside the piston. The screw pushing on the pin causes the pin to contact and push a stator backing plate. A lining is screwed to the stator backing plate, so when the stator backing plate is pushed by the pin, the lining is pushed into contact with a rotor. This conventional brake is a floating mount caliper brake, and therefore, when the lining pushes on the rotor, the brake slides on its mount, thereby causing another lining on another stator backing plate to push on an opposite side of the rotor.

To release this conventional brake to allow normal driving, hydraulic pressure is applied between a plug and the piston. Since the plug is trapped at the bottom of the piston bore, hydraulic pressure moves the piston toward the spring pack. This compresses the spring pack until a step on the piston contacts the end cap, which contact is a hard stop. The piston moving to the relative right to a released position pulls both the screw and the locknut with it. Since the pin is slidably mounted inside the piston, the pin loses contact with the screw, and is no longer urging the stator backing plate or the lining into contact with the rotor.

As the linings wear, the spring pack will need to stroke farther to move the lining into engagement with the rotor. The brake therefore needs periodic adjustment to reset the spring height to prevent loss of spring force.

To adjust this conventional brake, hydraulic pressure is applied. This could be done with a hand pump or by activating vehicle hydraulics. The lock nut is loosened, which allows the screw to be moved. A particularly sized shim is then placed between the rotor and one of the linings. The screw is then turned inward, until the screw is snug but not so tight that the shim cannot be removed. The lock nut is then tightened. As discussed above, this adjustment procedure therefore requires a hydraulic power source to release the brake. More critically, the adjustment screw and locknut for this conventional brake are exposed on the outside. In corrosive or muddy conditions, this screw will be covered in rust and dirt making it difficult to adjust. Likewise, the rotor and lining may have been covered in mud making access with a shim difficult.

This conventional brake allows for manual release of the brake, for towing purposes, assuming the locknut and the screw are not corroded and difficult to move. To manually release this conventional brake, the locknut is loosened and the screw is backed out about a half inch. Then, when the spring pack pushes out onto the piston, there is so much clearance between the screw and the pin that the piston bottoms out against the plug before the screw contacts, or applies any force to, the pin. Thus, no spring force is pushing the pin into the stator backing plate or the lining, and the brake turns freely. However, as mentioned above, this generally requires the externally located locknut and screw to not be corroded.

Separately, U.S. Pat. No. 8,127,897 discloses a Caliper Brake System. The '897 patent includes springs which generate thousands of pounds of force, and moreover includes a screw adjuster having a relatively large thread. Therefore, the thousands of pounds of axial force from the spring pack act on a large radius with a correspondingly large friction force therefore resisting rotation of the adjuster. As the thread of the adjuster is turned, the springs are further compressed against the force over that large radius, which creates a very large torque. It can be very difficult to turn a wrench to make that adjustment. Though, this can be deemed acceptable in the intended application of the '897 patent, such as there being ample room to use a very long wrench to turn the adjuster. However, other intended applications for brakes may be more limited in space.

The '897 patent also discloses a plate to seal a screw adjuster, which generally leads to more work, more parts, more space taken up, and more cost. Thus, it would be desirable to eliminate the plate while continuing to protect the adjuster threads from the external environment.

The '897 patent also can require a tool to be used for adjustment. Since torques on the adjuster can be very high, it can be necessary to use a properly fitted tool to ensure the adjuster can be turned without damaging the drive depression. This would require the mechanic to have that tool available and in good condition. It further requires that the depression itself remains undamaged by prior adjustments. It is possible that repeated adjustments will damage the drive depression making it difficult to turn the adjuster, particularly when the required torque for adjustment is high.

There remains a need in the art for an improved brake and an improved adjustment method for a brake.

### DISCLOSURE OF THE INVENTION

An object of one aspect of the present invention is a brake capable of being adjusted with minimal user effort, without the need for long tools, and without the need for any shims or other means of directly measuring the running clearance of the brake.

An object of another aspect of the present invention is a brake which includes protecting an adjuster mechanism from the environment while not requiring disassembly of additional parts to access the adjuster.

An object of a further aspect of the present invention is a brake which does not require a specific style or size or fit of a particular tool to adjust the brake.

An object of a still further aspect of the present invention is a brake which does not require a special shim for measuring and controlling brake adjustment.

These and other objects of the present invention, as well as the advantages thereof over existing prior art forms, which will become apparent from the description to follow, are accomplished by the improvements hereinafter described and claimed.

In general, a method of adjusting a brake includes providing a spring applied hydraulic release caliper brake, the spring applied hydraulic release caliper brake including a housing carrying springs acting on a piston in a default position, the housing further carrying an adjuster, with an outer portion of the adjuster being in direct contact with an outermost spring of the springs; releasing the brake from the default position to a released position, where the released position includes the piston contacting the adjuster; and rotating the adjuster a predetermined amount to thereby cause the springs and the piston to also rotate with the rotating of the adjuster, the step of rotating thereby removing an amount of clearance between the piston and a stator, such that the removing of the amount of clearance becomes a new default position for the spring applied hydraulic release caliper brake.

In accordance with another aspect of the invention, a spring applied hydraulic release caliper brake includes a housing carrying springs acting on a piston in a default position, the housing further carrying an adjuster, with an outer portion of the adjuster being in direct contact with an outermost spring of the springs; the spring applied hydraulic release caliper brake having a released position, where the released position includes the piston being in contact with the adjuster; and the adjuster being adapted to rotate a predetermined amount, the springs and the piston being adapted to rotate with the adjuster; the adjuster, the springs, and the piston thereby being adapted to remove an amount of clearance between the piston and a stator, such that the removal of the amount of clearance becomes a new default position for the spring applied hydraulic release caliper brake.

In accordance with yet another aspect of the invention, a method of adjusting a brake includes providing a spring applied hydraulic release caliper brake, the spring applied hydraulic release caliper brake including a housing carrying springs acting on a piston in a default position, the housing further carrying an adjuster, with an outer portion of the adjuster being in direct contact with an outermost spring of the springs; inserting a threaded bolt into a threaded hole within the piston; torquing the threaded bolt until the piston is contacting the adjuster; and rotating the adjuster a predetermined amount to thereby cause the springs and the piston to also rotate with the rotating of the adjuster, the step of rotating thereby removing an amount of clearance between the piston and a stator, such that the removing of the amount of clearance becomes a new default position for the spring applied hydraulic release caliper brake; wherein the steps of inserting, torquing, and rotating are devoid of utilizing hydraulic fluid, such that the spring applied hydraulic release caliper brake is adjustable by only mechanical components.

### BRIEF DESCRIPTION OF THE DRAWINGS

FIG. 1 is a front elevational view of a brake according to one or more embodiments of the present invention.

FIG. 2 is a sectional view taken substantially along line A-A of FIG. 1.

FIG. 3 is a sectional view taken substantially along line B-B of FIG. 1.

FIG. 4 is an expanded view taken substantially along region C of FIG. 2.

FIG. 5 is a front elevational view of an exemplary Belleville spring of the brake of FIG. 1.

FIG. 6 is a perspective view of the brake of FIG. 1 being mounted to a rear of a transmission.

FIG. 7 is an alternative perspective view of the mounted brake of FIG. 6.

FIG. 8 is a perspective view of the brake of FIG. 1.

FIG. 9 is a sectional view of the perspective view of FIG. 8.

FIG. 10 is a perspective view of an exemplary lined stator of the brake of FIG. 1.

FIG. 11 is an alternative perspective view of the brake of FIG. 1.

FIG. 12 is a sectional view of the brake of FIG. 1, about a clevis pin thereof.

FIG. 13 is a perspective view of a piston of the brake of FIG. 1.

### DETAILED DESCRIPTION

One or more embodiments of the present invention relate to a spring applied hydraulic release caliper brake. One or more embodiments of the present invention relate to a method of adjusting a spring applied hydraulic release caliper brake.

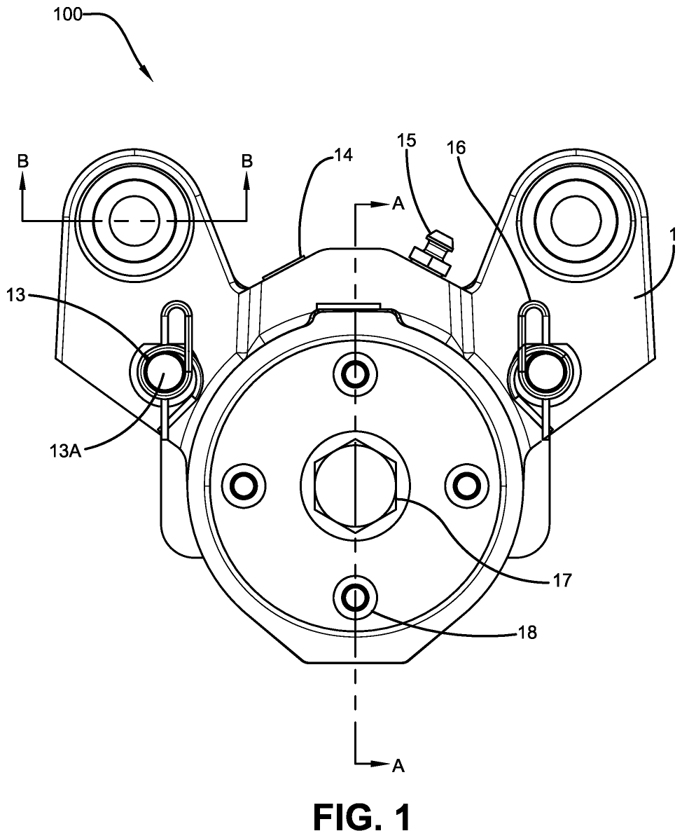

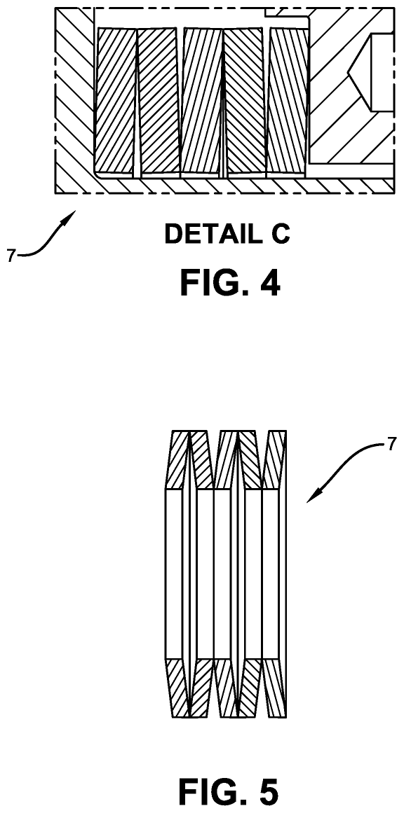

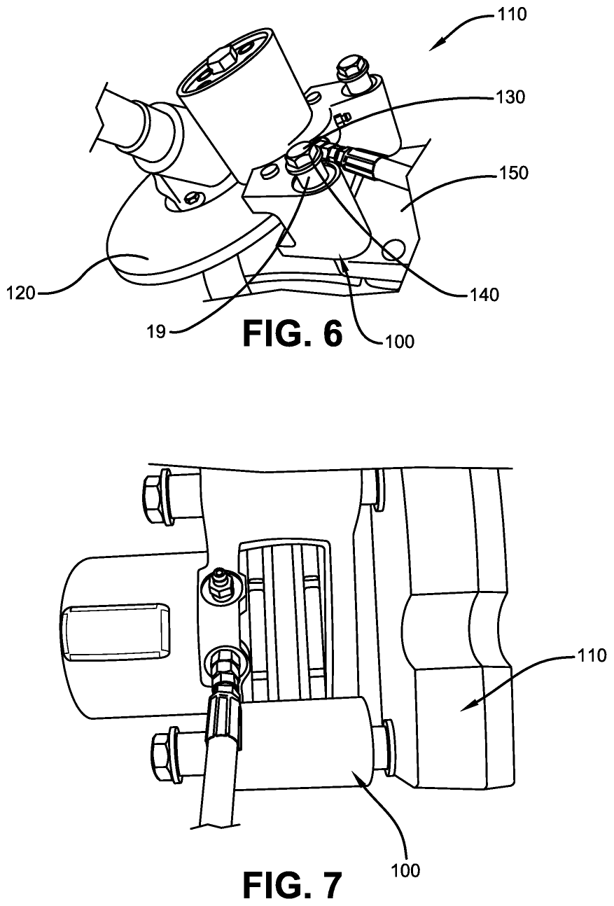

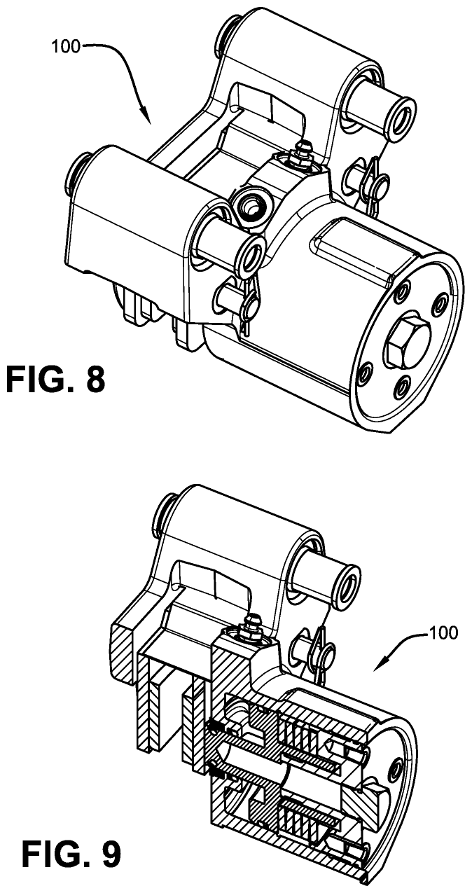

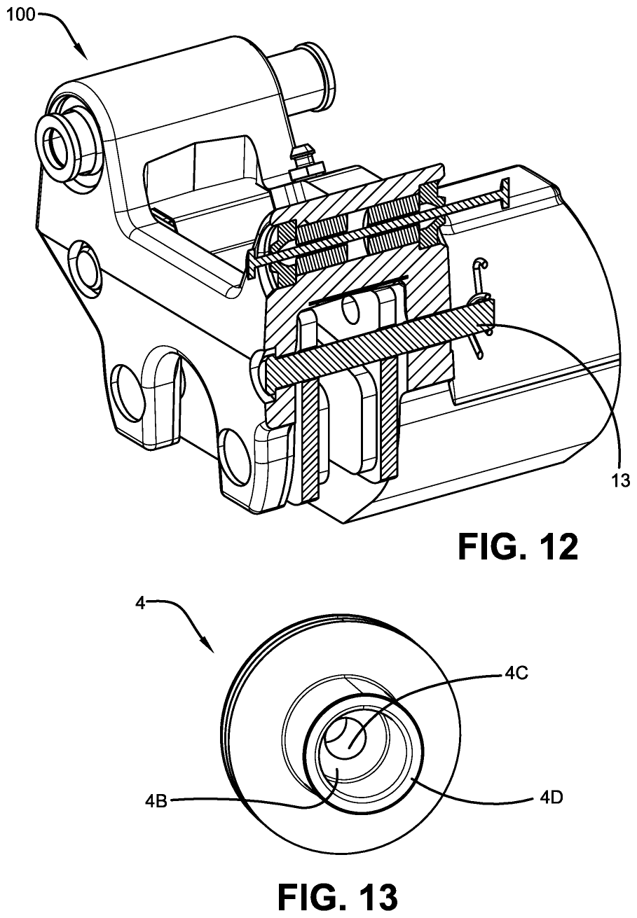

With reference to FIGS. 1 to 13, a spring applied hydraulic release caliper brake according to one or more embodiments of the present invention is generally indicated by the numeral 100. Spring applied hydraulic release (SAHR) caliper brake 100, which may also be referred to as caliper brake 100, brake 100, or SAHR brake 100, includes a housing 1 which carries and protects components of brake 100. Housing 1 also generally serves to locate brake 100 in operative relation to one or more other vehicle components 110 (FIGS. 6 and 7). The associated vehicle component 110 may be a transmission 110 other component on the driveline, such as a pinion shaft at the input to an axle. In other embodiments, brake 100 might be positioned inside a wheel.

Being a spring applied hydraulic released brake, SAHR brake 100 defaults to engaging the braking function. A first portion 1A of housing 1 includes a pack of springs 7 which act on a piston 4 to initiate the braking. A second portion 1B of housing 1 includes a pair of lined stators 2, including a first stator 2A and a second stator 2B, which stators 2 act on a rotor 120 for the braking function.

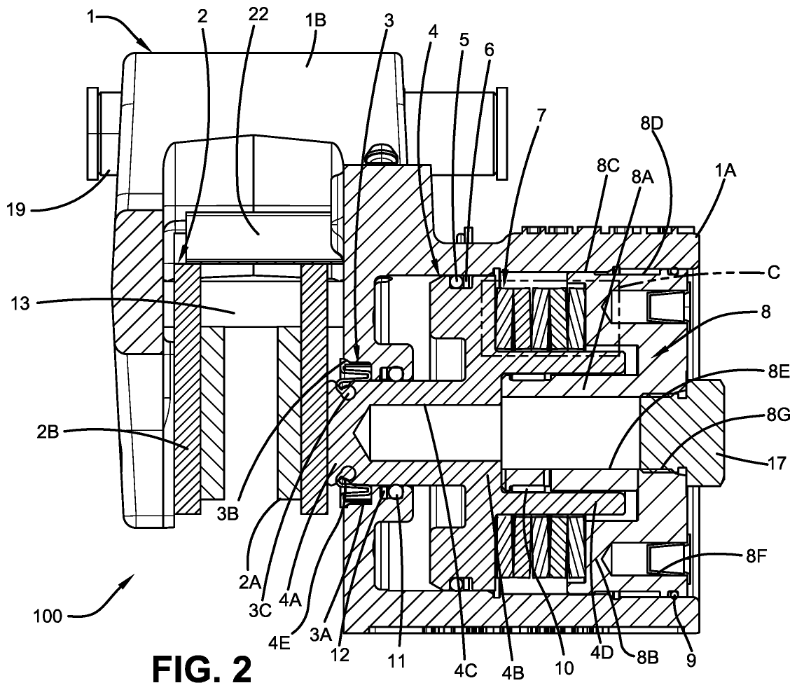

In the default position of brake 100, springs 7 urge piston 4 to the left, as shown in FIG. 2 (i.e., section A-A). This urging by springs 7 causes a distal end portion 4A of piston 4 to push into contact with first lined stator 2A, which in turn pushes on rotor 120.

A boot 3 is positioned around a portion of distal end portion 4A. A first end 3A of boot 3, and much of boot 3, is pressed into a machined bore 3B in housing 1. A second end 3C of boot 3 opposite the machined bore 3B in housing has a bulge formed thereon, such as by molding, which bulge is received into a groove 4E within distal end portion 4A in piston 4. Boot 3 should contain a sufficient number of accordion bellows to allow it to move axially throughout the working range of piston 4. Boot 3 generally serves to prevent water and debris contamination. If water and/or dirt enter piston 4 in the area between boot 3 and an O-ring 11 and a backup ring 12, corrosion might occur in this area, which area may be referred to as a piston bore. Preventing corrosion in this area is generally desirable as to prevent abrasion of O-ring 11 and to prevent piston 4 from rusting (and therefore ‘swelling’) as to prevent piston from seizing in the piston bore. Preventing corrosion is also desirable to prevent the brake 100 from leaking.

Brake 100 is a floating mount caliper brake, such that force from piston 4 pushing on first lined stator 2A causes the brake 100 to move to the right, as also shown in FIG. 2, until the other lined stator 2B on the opposite side of the rotor 120 also contacts the rotor 120. Thus, the braking effect is initiated on both sides of the rotor. FIG. 2 shows a pad gap between the stators 2A and 2B which is where the rotor 120 would be positioned.

This default position of brake 100 occurs until hydraulic pressure is applied or a mechanical release is effected. As further described herein, the hydraulic pressure would be applied to the area between an O-ring 5, which may be referred to as a first O-ring 5, and the O-ring 11, which may be referred to as second O-ring 11. As shown in FIG. 2, O-ring 5 can be paired with a backup ring 6 and second O-ring 11 can be paired with backup ring 12. O-rings 5, 11 and backup rings 6, 12 seal piston 4 against the piston bores of housing 1.

As mentioned above, brake 100 includes a pack of springs 7, which may also be referred to as springs 7 or spring pack 7. The Figures show SAHR brake 100 with disc springs 7, which may also be referred to as Belleville washers 7, Belleville springs 7, or flat Belleville springs 7. These are non-linear springs. That is, the force they generate is not directly proportional to spring deflection as would be the case with a coil spring (according to Hooke's law). Belleville springs 7 generally take up relatively less space and can generate relatively large force. A drawback to these Belleville springs 7 can be that they have a very short stroke. In their working range, the force versus deflection curve is relatively flat, but as they stroke farther and farther out towards their free length, there is a precipitous drop in the force curve.

In the case of SAHR brake 100, the springs 7 are generally pushing against a lined stator pad 2A. The nature of a Belleville spring 7 can pose a problem with a brake that is spring applied, because the spring force is the source of braking force. Utilizing only a single Belleville spring might be very sensitive to tolerance and wear, because the single Belleville spring would have a relatively small working range. This use of a single Belleville spring would make brake torque difficult to control and to keep within a good working range, particularly with wear.

Therefore, to compensate for the rather short working range, these springs 7 can be arranged in series. In mechanical systems, objects arranged in series are generally subject to the same forces, i.e., each spring 7 is subject to the same force. Since each spring 7 is subject to the same force, each spring 7 will be at the same deflection (from its free length) that corresponds to that force. Since springs 7 are arranged in series, the total deflection is the deflection of one spring times the total number of springs. This generally serves to increase the overall deflection and stroke capacity and reduces the sensitivity of brake 100 to tolerance and wear.

There are five springs 7 shown in the Figures, though other numbers, for example, seven and nine, and other arrangements are also possible.

Even with arranging springs 7 in a series spring arrangement, the wear of brake 100 should be considered, for adjusting brake 100 accordingly. As brake 100 wears, the running clearance of brake 100 will increase, where running clearance is the pad gap at the released position minus the rotor thickness. For the braking components to properly engage in the worn condition, the springs 7 will have to travel farther to compensate for the wear. This reduces the deflection of springs 7 from free length when the brake 100 is engaged and therefore reduces the force available for braking. At some point, the spring pack 7 reaches a critical length, and the force from the springs 7 pushing on the lined stator pad 2A drops off relatively rapidly. Thus, the brake 100 should be kept properly adjusted. By adjusting the brake 100, the springs 7 are reset to their proper working height with the proper running clearance, so that brake torque can be kept in its proper range.

To assist with this adjustment, an adjuster 8 is positioned into the end of housing portion 1A. An inner portion 8A, which is generally cylindrical, of adjuster 8 is proximate piston 4 and is within a generally cylindrical extension 4D of piston 4. An outer portion 8B of adjuster 8 is in direct contact with springs 7, particularly in contact with an outermost one of springs 7. More specifically, an inner face of outer portion 8B is in contact with the outermost one of springs 7. Said another way, springs 7 are positioned between adjuster 8 and piston 4.

Positioned in a groove on an outside diameter on an outboard axial end of adjuster 8 is an O-ring 9 that generally seals the brake 100 from external contaminants and water. This O-ring 9 seals the adjuster 8 without the need for a separate plate. This configuration therefore does not include a plate and screw configuration, such as disclosed in U.S. Pat. No. 8,127,897.

An inboard portion of the axial end of adjuster 8 should include threads 8C on the outside diameter, which threads 8C are accepted by a mating thread in housing portion 1A.

A relief 8D can be axially positioned between the rod diameter of the O-ring surface 9 and the threads 8C. The relief can generally serve to assist with machining the threads.

Adjuster 8 contains a bore 8E, which can be a centrally located threaded bore 8E. The bore 8E is adapted to accept a plug 17, which can be referred to as a sealed plug 17. Examples for plug 17 include an O-ring hex socket plug 17 (as shown in the Figures) and a pipe plug. The O-ring hex socket plug 17 seals the bore 8E under normal operation. Removal of the O-ring hex socket plug 17 from bore 8E for adjustment will be further discussed herein.

Adjuster 8 also contains holes 8F, which are shown as unthreaded, blind holes 8F, within the outer portion 8B. Holes 8F begin at an outer face of the outer portion 8B. As shown in the Figures, adjuster 8 can include four holes 8F, which can be spaced equidistant with each other. Other numbers and configurations may also be suitable. Under normal operation, plastic plugs 18 can be placed into the holes 8F to protect the holes 8F from mud and corrosion. Optional removal of the plugs 18 and insertion of pins or bolts for adjustment will be further discussed herein. In other embodiments, holes 8F can be threaded.

Adjuster 8 also receives a wear ring 10, which may also be referred to as guide ring 10, within a groove. Wear ring 10 provides bushing support between adjuster 8 and piston 4, so that piston 4 can move freely in an axial direction, and adjuster 8 can move both axially and rotationally, without piston 4 and adjuster 8 impinging or otherwise interfering with one another. The wear ring 10 can be generally C-shaped and be formed from any suitable material, such as polyamide (i.e., nylon), polytetrafluoroethylene (PTFE), glass, graphite, bronze, and composites thereof.

Before describing further aspects of an adjustment method, aspects of releasing SAHR brake 100 are now described. As mentioned above, the default position of brake 100 is the braking position. This ensures the SAHR brake 100 automatically performs the braking function for certain vehicle operation instances. This braking function therefore needs to be overcome before an adjustment can be made. And even prior to any adjustment, this braking function needs to be overcome to release the braking function for moving the associated vehicle.

To release the brake 100 for driving the associated vehicle, hydraulic fluid pressure is applied to a hydraulic inlet port 14, which may also be referred to as a boss 14. This inlet port 14 allows fluid communication between a hydraulic system of the vehicle and the area behind piston 4. The fluid pressure is directed from the port 14 to the area generally between O-ring 5 and O-ring 11. This urges piston 4 to the right (i.e., in the configuration of FIG. 2; Section A-A), thereby compressing springs 7, until a counterbore 4B of piston 4 contacts a nose of inner portion 8A of adjuster 8. This contact between piston 4 and adjuster 8 is a hard stop to prevent over compressing springs 7, which over compressing would otherwise cause damage.

For reverting back to the default position, the hydraulic fluid pressure can then be bled from a bleeder 15, which may also be referred to as a boss 15 or a bleeder port 15, for releasing the pressure, which may also be referred to as bleeding the brake 100. The bleeder 15 can include a bleeder screwed into a hole. The holes of inlet port 14 and bleeder port 15 can be the same size, so that an inlet hose or the bleeder can be switched to either hole.

The brake 100 can also be released in a scenario where the hydraulic system of the associated vehicle is inoperable. This can include scenarios where the vehicle is desired to be towed. SAHR brake 100 includes a screw mechanism for this purpose. As will be further disclosed herein, this screw mechanism can also be utilized for adjustment of brake 100.

To mechanically release or adjust the brake 100, O-ring hex socket plug 17 should first be removed from threading 8G within bore 8E in adjuster 8. A bolt and washer (not shown) are then inserted through the bore 8E in adjuster 8 and threaded into a threaded central hole 4C in piston 4. As suggested above, this mechanism can be used for mechanical release both for towing and for adjustment.

The washer should be big enough to completely cover the threaded bore 8E in adjuster 8, so the bolt can react axial force against adjuster 8. An exemplary bolt is ⅝-11 UNC, but other thread sizes are possible. As mentioned above, the bolt should clear the threads 8G of threaded bore 8E in adjuster 8, which threads may be sized at ¾-16, though other sizes may be suitable. This allows the bolt to turn without interference with the threaded bore 8E in adjuster 8. As the bolt is tightened, it pulls piston 4 towards adjuster 8, until the hard stop counterbore 4B of piston 4 contacts the nose of adjuster 8, as described above. In this position (not shown), piston 4 is completely not in contact with lined stator 2A, so the brake 100 is released.

For a bolt sized ⅝″, the torque required to overcome around 5,000 lbs. of spring force is not relatively high. A ⅝″ bolt can generate around 5,000 lbs. of spring force at relatively moderate torque, such as about 50 ft lbs. In one or more embodiments, brake 100 requires approximately ⅕th of the required torque to release the brake disclosed in U.S. Pat. No. 8,127,897. As further description, a grade 8, ⅝-11 bolt can safely produce around 20,000 lbs. of force, so the capacity mentioned above is about ¼ of the available capacity of this sized bolt. In this way, the spring load can be varied considerably without changing bolt size.

Further description of adjusting brake 100 is now provided. First, the brake needs to be released. As suggested above, this can be done by either of two primary techniques. In both techniques, plug 17 will first be removed from adjuster 8.

In a first technique for releasing brake 100 for adjustment, hydraulic pressure is used to release the brake 100. The hydraulic fluid pressure can be from vehicle hydraulics or from a hand pump. This moves piston 4 against adjuster 8 as described herein. The bolt is then inserted, as described herein, and turned enough to hold piston 4 against adjuster 8. While the bolt is utilized for this first technique, no torque has to be applied thereto in the first technique, as the hydraulic fluid pressure provides the movement force for moving piston 4 into contact with adjuster 8. The hydraulic pressure is then released, such that the bolt will be holding the load. Of note, for these kinds of hydraulic systems, whether a hand pump or vehicle hydraulics, the line coming into the brake 100 will generally be a dead head. Thus, the brake line to the fluid pressure source will need to be opened to tank pressure (i.e., at atmospheric pressure) to release pressure in order to adjust the brake. Otherwise, the piston 4 and adjuster 8 will not be able to move together for brake adjustment. The brake 100 is then adjusted, as further described herein below.

In a second technique for releasing brake 100 for adjustment, no hydraulic pressure is needed. As described herein, plug 17 is removed, and the bolt (e.g., ⅝-16 UNC bolt) is inserted and torqued (e.g., about 50 ft lbs.). This moves piston 4 into contact with adjuster 8. The brake 100 is then adjusted, as further described herein below.

With the brake 100 released, the adjuster 8 will be turned in order to perform the adjustment, which may be referred to as rotating adjuster 8 a predetermined amount. Since the springs 7 are already compressed, and piston 4 and adjuster 8 are in contact with one another, turning the adjuster 8 does not further compress the springs 7. The only resistance to adjuster 8 rotation is O-ring drag, because springs 7 are not being further compressed, which makes moving the adjuster 8 relatively easy. Rotating adjuster 8 rotates adjuster 8, springs 7, piston 4, possibly O-rings 5, 11, and possibly backup rings 6, 12 together. Rotation of adjuster 8 moves these components axially to the left (relative to FIG. 2/Section A-A), until piston 4 contacts stator 2A and takes up all running clearance, or until another factor is utilized relative to the desired adjusted clearance. For example, a shim (not shown) can be placed between one of the lined stators 2 and the rotor 120, and then the adjuster 8 is turned until the shim can be just pulled out of that gap.

The amount that adjuster 8 will be turned can be determined by either of two techniques. In a first technique, the threading can be used in order to determine how far the adjuster 8 has moved or needs to move. This also can be correlated to the distance of rotation of the adjuster 8. That is, the adjuster 8 can be turned until all running clearance is taken up. Then, the adjuster 8 can be backed off a specified number of turns, and/or parts of a turn, to provide the desired clearance. In a second technique, the shim can be used as described above.

Turning the adjuster 8 might be done simply by hand without the use of a tool, particularly where no components are corroded or packed with mud or debris. In other embodiments, the plugs 18 can be removed from holes 8F and pins or bolts can be inserted in the holes 8F, which pins or bolts should be generally sized to fit the holes 8F.

Where pins or bolts are utilized within holes 8F, the portions thereof which extend beyond holes 8F can be used for assistance with turning the adjuster 8. To turn the adjuster 8, a tool such as a pry bar can be placed between two adjacent extensions, which may be referred to as heads. The tool would be placed over the top of one pin or bolt and below the adjacent pin or bolt. Pushing the tool would then cause the adjuster 8 to turn. Said another way, one or more embodiments do not require a depression or other drive surface that may get damaged with repeated use or corrosion.

Once the adjustment is made, the brake 100 is unreleased, plug 17 is replaced, and the brake adjustment is complete.

Further details of the floating design and the stators and braking function are now provided.

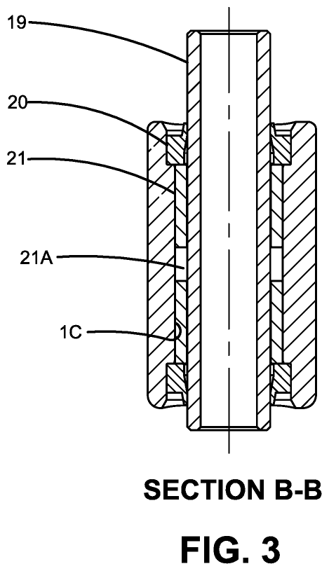

To accomplish the floating design, two sleeves 19 can be slidably mounted inside bushings 21. The brake 100 in the Figures includes two bushings 21 with each sleeve 19 for a total of four bushings 21. The bushings 21 are pressed into mating bores 1C (FIG. 3) in housing 1 from both ends. Bushings 21 are press fit into their mating bores 1C in housing 1 and are fixed in position by the press fit. A gap 21A between the bushings 21 exists. This configuration can be easier for assembly, since an otherwise longer bushing could be harder to press in without damage. However, other embodiments may utilize a single bushing within each sleeve 19.

Brake 100 of the Figures is shown as a two-sleeve (i.e., sleeves 19) mounting design, since that is the minimum number of sleeves required. However, other embodiments may utilize a higher number of mounting bolts and sleeves, such as four. Other numbers may be based on accommodating a particular mounting bolt design for certain vehicles.

Bushing 21 can be made from sintered bronze material, which can be impregnated with grease to make it self-lubricating. This is commercially available under the tradename Oilite®. Other materials such as Teflon® coated steel or even some bearing grade plastics may be possible.

Sleeves 19 can be made from heat treated steel for strength. The outside diameter of sleeve 19 should also be protected from corrosion. This can be done by ferritic nitrocarburzing, a chemical bath process that introduces nitrogen into a thin layer of the part, adding a very thin hard layer with corrosion resistance. This process is commonly called salt bath nitriding. Other possible solutions could include electroless nickel plating or chrome plating.

The bores 1C for bushings 21 can be sealed on both ends by lip seals 20. This generally prevents water, dirt, and other contaminants from entering the bushing bore 1C. Lip seals 20 can be press fit into their respective bores 1C in housing 1.

In one or more embodiments, there may be no need for greasing of the area between bushings 21, because bushing 21 is self-lubricating. In other embodiments, a grease fitting may be fit to grease the sleeve 19 and bushing 21 interface to ensure lubrication.

The brake 100 can be mounted to the vehicle 110 by inserting bolts 130 with hardened washers 140 through sleeves 19. The bolts 130 can be threaded into a mounting bracket 150. Another hardened washer (not seen) is placed between the mounting bracket 150 and sleeve 19. The bolts 130 are tightened, and sleeve 19 is clamped between the head of the bolt 130 and washer 140 on one end and a washer and mounting sleeve on the other end.

Since sleeve 19 is slidably mounted inside bushing 21, the brake 100 can freely move axially on the sleeves 19. Thus, when springs 7 urge piston 4 to move left against stator 2A (relative to FIG. 2/Section A-A), which pushes against the rotor 120, the brake 100 moves to the right, until stator 2B on the opposite side of the rotor 120 contacts the rotor 120. This accomplishes the brake floating described herein.

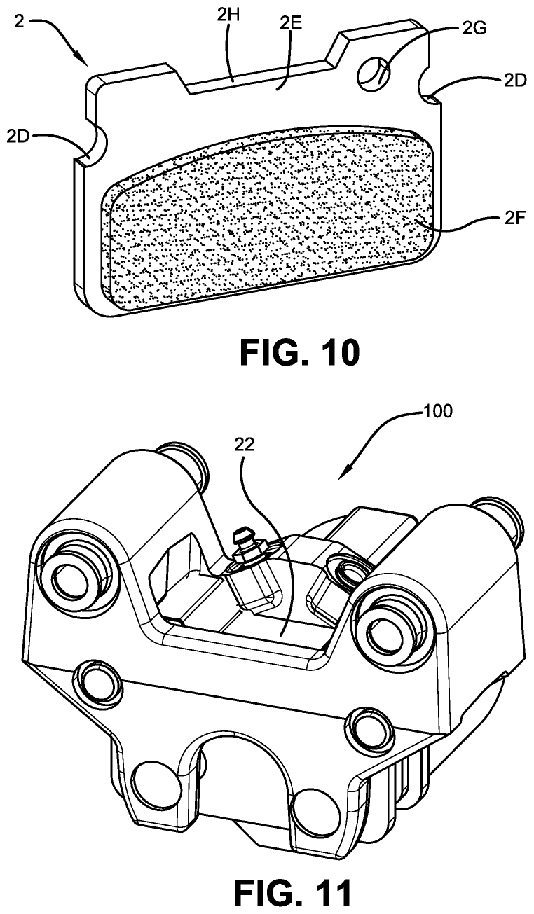

Lined stators 2 are mounted on two pins 13, which can be clevis pins 13. The clevis pins 13 are accepted into two notches 2D (FIG. 10) formed into a backing plate 2E of lined stator 2. When lining 2F of lined stator 2 is pushed into contact with the rotor 120 as described herein, torque is applied to lined stator 2. This torque is reacted by clevis pin 13 acting on the notches 2D in lined stator 2.

Lined stator 2 can include a hole 2G at the top. This is for processing reasons, so that the stator 2 can be hung by a hook to allow dipping the part in resin or a similar bonding material. Likewise, there can be two holes (not shown) in the backing plate 2E. These would also be for processing purposes to accommodate compression molding of the lining.

Lined stator 2 can also include a relief 2H at the top of the part. This is generally to provide clearance to bosses 14, 15 on housing 1.

A clip 22 (FIG. 11), which may also be referred to as a cover 22, may be provided over top of the stators 2. This clip 22 can provide a relatively slight tension on the stators 22 in order to serve as an anti-rattle component. Clip 22 can be made from stainless steel to prevent corrosion, and zinc plated steel or other coatings on plain carbon steel are also suitable.

For mounting the stators 2, clevis pins 13 can be inserted into a mating hole in housing 1 from the carrier side of the caliper. Since clevis pin 13 has a head 13A, the head 13A prevents clevis pin 13 from going too far into the carrier side of housing 1. A wire clip 16, which may also be referred to as a rue clip 16, is inserted into a radial hole in clevis pin 13 to hold clevis pin 13 in the axial position on the opposite side of housing 1.

Clevis pin 13 should be heat treated and corrosion protected. An exemplary coating is available under the tradename Geomet® L, which is a commercially available, though a proprietary composition, water-based coating including metal oxides, metallic zinc, and aluminum flake. The L refers to a topcoat silicate sealer that further improves corrosion resistance. Since the Geomet® coating would not be an electroplate process, such as utilizing zinc or chrome, there is no risk of hydrogen embrittlement. However, electroplating can be a potential alternate for Geomet® coating. Electroless nickel would be another option.

As further advantages of brake 100, brake 100 does not include an unsealed adjuster screw outside of the brake, as to avoid corrosion and other damage, including leakage of water through the threads to the internal features of brake 100. Moreover, brake 100 does not use screws to attach linings to the carrier and/or stator backing plate. Brake 100 may be used in applications in the off-highway market including vehicles for underground mining, airplane tow tractors, and various agricultural machines.

It is thus evident that a brake constructed and operated as described herein accomplishes the objects of the present invention and otherwise substantially improves the art.

What is claimed is:

1. A method of adjusting a brake, the method comprising steps of
providing a spring applied hydraulic release caliper brake, the spring applied hydraulic release caliper brake including a housing carrying springs acting on a piston in a default position, the housing further carrying an adjuster, with an outer portion of the adjuster being in direct contact with an outermost spring of the springs;
releasing the brake from the default position to a released position, where the released position includes the piston contacting the adjuster; and
rotating the adjuster a predetermined amount to thereby cause the springs and the piston to also rotate with the rotating of the adjuster, the step of rotating thereby removing an amount of clearance between the piston and a stator, such that the removing of the amount of clearance becomes a new default position for the spring applied hydraulic release caliper brake.

2. The method of claim 1, where the step of releasing the brake includes applying hydraulic fluid pressure in an area behind the piston, which hydraulic fluid pressure results in the piston contacting the adjuster, where the step of releasing further includes inserting a threaded bolt into a threaded hole within the piston without torquing the threaded bolt, where the method further includes a step of releasing the hydraulic fluid pressure prior to the step of rotating the adjuster.

3. The method of claim 1, where the step of releasing the brake includes inserting a threaded bolt into a threaded hole within the piston, and torquing the threaded bolt until the piston is contacting the adjuster.

4. The method of claim 1, where the step of releasing the brake includes a first sub-step of removing a plug from a bore within the adjuster.

5. The method of claim 4, where the plug is a sealed plug, where the bore is a centrally located threaded bore.

6. The method of claim 1, where the step of rotating the adjuster is performed by hand without the use of a tool.

7. The method of claim 1, where the step of rotating the adjuster includes utilizing threading to establish the removing of the amount of clearance between the piston and the stator.

8. The method of claim 1, where the step of rotating the adjuster includes utilizing a shim to establish the removing of the amount of clearance between the piston and the stator.

9. The method of claim 1, where the outer portion of the adjuster includes holes receiving respective plugs during normal operation, the method further comprising removing the plugs, inserting respective pins into the holes, placing a tool over a top of one pin and below an adjacent pin, and pushing the tool to cause the adjuster to perform the step of rotating.

10. A spring applied hydraulic release caliper brake comprising
a housing carrying springs acting on a piston in a default position, the housing further carrying an adjuster, with an outer portion of the adjuster being in direct contact with an outermost spring of the springs;
the spring applied hydraulic release caliper brake having a released position, where the released position includes the piston being in contact with the adjuster; and
the adjuster being adapted to rotate a predetermined amount, the springs and the piston being adapted to rotate with the adjuster;
the adjuster, the springs, and the piston thereby being adapted to remove an amount of clearance between the piston and a stator, such that the removal of the amount of clearance becomes a new default position for the spring applied hydraulic release caliper brake.

11. The spring applied hydraulic release caliper brake of claim 10, the piston including a threaded hole adapted to receive a threaded bolt in order to put the spring applied hydraulic release caliper brake in the released position.

12. The spring applied hydraulic release caliper brake of claim 10, the adjuster including a centrally located threaded bore with a sealed plug received therein.

13. The spring applied hydraulic release caliper brake of claim 12, where the sealed plug is either an O-ring hex socket plug or a pipe plug.

14. The spring applied hydraulic release caliper brake of claim 10, the outer portion of the adjuster including holes, the holes being adapted to receive respective pins therein in order to assist with the adjuster being adapted to rotate the predetermined amount.

15. A method of adjusting a brake, the method comprising steps of
providing a spring applied hydraulic release caliper brake, the spring applied hydraulic release caliper brake including a housing carrying springs acting on a piston in a default position, the housing further carrying an adjuster, with an outer portion of the adjuster being in direct contact with an outermost spring of the springs;
inserting a threaded bolt into a threaded hole within the piston;
torquing the threaded bolt until the piston is contacting the adjuster; and
rotating the adjuster a predetermined amount to thereby cause the springs and the piston to also rotate with the rotating of the adjuster, the step of rotating thereby removing an amount of clearance between the piston and a stator, such that the removing of the amount of clearance becomes a new default position for the spring applied hydraulic release caliper brake;
wherein the steps of inserting, torquing, and rotating are devoid of utilizing hydraulic fluid, such that the spring applied hydraulic release caliper brake is adjustable by only mechanical components.

16. The method of claim 15, further comprising a step of removing a sealed plug from a bore within the adjuster prior to the step of inserting.

17. The method of claim 15, where the step of rotating the adjuster is performed by hand without the use of a tool.

18. The method of claim 15, where the step of rotating the adjuster includes utilizing threading to establish the removal of the amount of clearance between the piston and the stator.

19. The method of claim 15, where the outer portion of the adjuster includes holes receiving respective plugs during normal operation, the method further comprising removing the plugs, inserting respective pins into the holes, placing a tool over a top of one pin and below an adjacent pin, and pushing the tool to cause the adjuster to perform the step of rotating.

20. The method of claim 15, where the step of rotating the adjuster includes utilizing a shim to establish the removing of the amount of clearance between the piston and the stator.
